(19) United States
(12) Patent Application Publication
(10) Pub. No.: US 2026/0249664 A1
(43) Pub. Date: Aug. 27, 2026

(54) METHODS AND APPARATUS FOR UTILIZING A FLUID COUPLING FOR HEATING AND ENERGY DISSIPATION IN ELECTRIC VEHICLES

(71) Applicant: Ford Global Technologies, LLC, Dearborn, MI (US)

(72) Inventors: Jonathan Hair, Northville, MI (US); Matthew David Penne, Pierce, NE (US); Nicholas Church, Allen Park, MI (US)

(21) Appl. No.: 19/061,768

(22) Filed: Feb. 24, 2025

(51) Int. Cl. B60H 1/02; B60L 58/27; F16H 45/02

(52) U.S. Cl. CPC B60H 1/02; B60L 58/27; F16H 45/02; B60L 2240/507; B60L 2240/545

(57) ABSTRACT

Methods and apparatus for utilizing a fluid coupling for heating and energy dissipation in electric vehicles are disclosed. An example apparatus includes a torque converter to operatively couple an output shaft of an electric motor and a drive shaft of a vehicle. A clutch is movable between an engaged position and a disengaged position. The clutch fluidly couples the output shaft and the drive shaft via a first fluid of the torque converter when the clutch is in the disengaged position. The clutch mechanically couples the output shaft and the drive shaft when the clutch is in the engaged position. A heating system extracts heat from the first fluid of the torque converter to increase a temperature of a second fluid, where the second fluid provides heat to at least one of a cabin of the vehicle or a battery of the vehicle.

### FIELD OF THE DISCLOSURE

This disclosure relates generally to vehicles and, more particularly, to methods and apparatus for utilizing a fluid coupling for heating and energy dissipation in electric vehicles.

### BACKGROUND

Electric vehicles (EVs) employ electric motors or electric machines to apply torque to rotate wheels of the electric vehicles. Typically, heat generated by the electric motors is employed as a heat source for providing heat to a cabin of the vehicle and/or to a battery pack of the vehicle.

### SUMMARY

An example apparatus includes a torque converter to operatively couple an output shaft of an electric motor and a drive shaft of a vehicle. A clutch is movable between an engaged position and a disengaged position. The clutch fluidly couples the output shaft and the drive shaft via a first fluid of the torque converter when the clutch is in the disengaged position. The clutch mechanically couples the output shaft and the drive shaft when the clutch is in the engaged position. A heating system extracts heat from the first fluid of the torque converter to increase a temperature of a second fluid, where the second fluid provides heat to at least one of a cabin of the vehicle or a battery of the vehicle.

An example apparatus includes an electric motor having an output shaft, a drive shaft to drive one or more wheels of a vehicle, a fluid torque converter to operatively couple the output shaft of the electric motor and the drive shaft, and a clutch movable between an engaged position and a disengaged position. The clutch fluidly couples the output shaft of the electric motor and the drive shaft when the clutch is in the disengaged position. The clutch enables the electric motor to bypass the fluid torque converter to mechanically couple the output shaft of the electric motor and the drive shaft when the clutch is in the engaged position. The apparatus further includes an interface circuitry, machine readable instructions, and programmable circuitry to at least one of instantiate or execute the machine readable instructions to detect a torque converter slip condition request, and move the clutch to the disengaged position in response to at least one of: determining a cabin temperature that is less than a cabin temperature threshold, determining a battery temperature that is less than a battery temperature threshold, or determining a regeneration mode and at least one of determining a state of charge of the battery exceeding a charge capacity threshold or the battery temperature less than the battery temperature threshold.

In yet another example, at least one non-transitory machine-readable medium includes machine-readable instructions to cause at least one processor circuit to detect a torque converter slip condition request, detect a cabin temperature, detect a battery temperature of a battery, determine a state of charge capacity of the battery, detect a non-regeneration mode or a regeneration mode, and in response to detecting the non-regeneration mode, cause a clutch of a torque converter to move to a disengaged position in response to at least one of determining the cabin temperature is less than a cabin temperature threshold, or determining a battery temperature is less than a battery temperature threshold, or in response to detecting the regeneration mode, cause the clutch of the torque converter to move to the disengaged position in response to at least one of the state of charge of the battery exceeding a charge capacity threshold or the battery temperature not exceeding the battery temperature threshold.

### BRIEF DESCRIPTION OF THE DRAWINGS

FIG. 1 is a perspective view of an example vehicle in which examples disclosed herein can be implemented.

FIG. 2 is a schematic illustration of an example transmission system of the example vehicle of FIG. 1.

FIG. 3A is a side, partial cutaway view of an example fluid coupling of FIG. 2 with an example lock-out clutch in an example closed position.

FIG. 3B is a side, partial cutaway view of the example fluid coupling of FIG. 3A with the example lock-out clutch in an example open position.

FIG. 4 is a schematic illustration of an example slip condition system of the example vehicle of FIG. 1 in accordance with teachings of this disclosure.

FIG. 5 is a block diagram of an example implementation of example slip condition circuitry of FIG. 4.

FIGS. 6-8 are flowcharts representative of example machine readable instructions and/or example operations that may be executed, instantiated, and/or performed by example programmable circuitry to implement the example slip condition circuitry of FIG. 5.

FIG. 9 is a block diagram of an example processing platform including programmable circuitry structured to execute, instantiate, and/or perform the example machine readable instructions and/or perform the example operations of FIGS. 6-8 to implement the example slip condition circuitry of FIG. 5.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Electric vehicles often employ a Positive Temperature Coefficient (PTC) heater to generate heat that can be used to heat a cabin and/or a battery. A PTC heater is a type of electrical resistance heater that self-regulates its temperature. This means that as the temperature of the heater increases, its electrical resistance also increases, which in turn reduces the current flow and heat output. PTC heaters are disadvantageous for use with electrical vehicles because PTC consume energy (stored energy of a battery). In place of PTC heaters, some electric vehicles employ an electric drive lossy mode to generate heat that can be used to heat a cabin and/or a battery. In the context of electric vehicles (EVs), “lossy mode” typically refers to a state or condition where the vehicle's energy efficiency is reduced due to various factors. This can include energy losses in the battery, motor, or other components. These losses can be due to heat, resistance, or other inefficiencies in the system.

However, lossy modes are inefficient due to excess heat generation, power conversion losses, magnetic losses (e.g., due to hysteresis and eddy currents in magnetic materials), control system inefficiencies, and/or mechanical losses. For instance, a large amount of energy can be wasted via lossy mode heating. For example, lossy mode often results in heat generation of components like inverters and electric machines (e.g., motors), where such components require cooling to manage heat generation, which consumes additional energy and reduces overall efficiency. Some inefficiencies are due to heat loss by inverters converting energy from DC power from the battery to AC power for the electric motor. In some instances, due to inefficient operation of the electric motor and/or other systems during lossy mode, mechanical components such as bearings and gears can produce losses due to friction and wear. In some examples, effectiveness of heat transfer of a lossy mode electric drive system is approximately 20 percent. As a result, for every 3 kilowatts of energy provided by a lossy system, approximately 600 watts of energy reaches the battery cells for heating purposes. Additionally, using lossy mode at low motor speeds can cause torque ripple (e.g., variation in torque output of the electric motor) and non-uniform heating for both the electric motor and an inverter of the electric motor, which may lead to overheating. Further, motor cooling effectiveness increases with rotor speed. Thus, at low rotor speeds, limited heat can be extracted from the electric motor. As a result, cooling systems in electric vehicles reject heat to the surrounding environment rather than effectively transferring that heat from one component to another. The heat transfer path has many losses to the environment and poor effectiveness in the lossy mode. application. For example, in lossy mode, heat transfers from motor windings to oil coolant that flows through an oil-to-antifreeze (e.g., glycol) liquid heat exchanger, through complex coolant hose system(s), and to the battery module heat exchangers coupled to the battery cells.

Examples disclosed herein harvest energy or heat generated by a fluid coupling or torque converter to provide heating when the torque converter operates in a slip condition or a slip mode. Specifically, example fluid couplings disclosed herein enable slip between an output shaft of a motor and an input or drive shaft of a transmission. As used herein, “slip” refers to relative movement between the output shaft and the drive shaft. In other words, the input shaft of the fluid coupling coupled to an electric motor has a speed or torque that is different than a speed or torque of the drive shaft coupled to the fluid coupling. Thus, in examples disclosed herein, slip is induced between an impeller and a turbine within the fluid coupling or torque converter. The slip induces friction and turbulent based heat in the fluid (e.g., oil) of the fluid coupling or torque converter. For example, heat generated from oil of a torque converter or fluid coupling during a slip condition is employed to heat glycol of an environmental control. With the use of a liquid-to-liquid heat exchanger, heat generated by the fluid coupling or torque converter is channeled to or used in association with a cabin heating loop, a battery heating loop, and/or to other power electronics or components of the vehicle. A fluid coupling or torque converter that is designed to dissipate its heat to a liquid heat exchanger can be much more effective and/or efficient than the heat transfer path from the electric motor. The heat exchanger can be a fluid-to-fluid heat exchanger, a shell and tube heat exchanger, a plate heat exchanger, a brazed plate heat exchanger, a round-tube-fin (RTPF) heat exchanger, a microchannel heat exchanger and/or any other type of heat exchanger(s).

Employing a fluid coupling or torque converter to generate heat reduces, minimizes or eliminates the need to use heat from the electric motor. More effective cooling caused by faster rotor speed allows for a greater amount of heat extraction from an electric motor. As a result, greater heating can be achieved using less energy, which increases battery range of the vehicle. The example systems and methods disclosed herein result is a more effective and/or efficient heating mode (i.e., less energy input for a given amount of heating output). Further, operating an electric motor or electric drive at greater revolutions per minute (RPM) limits torque ripple and/or noise, vibration, and harshness (NVH) in electric vehicles.

Additionally, examples disclosed herein assist with energy dissipation. For example, during regeneration conditions while driving, example fluid couplings or torque converters disclosed herein can be positioned to operate in an unlocked state to allow for a speed differential when a state of charge capacity of the vehicle battery exceeds a threshold (e.g., 90 percent energy capacity, 100 percent energy capacity). For example, if the battery has a full state of charge (e.g., a 100% charge status) while the vehicle is driving downward along a grade and the control system is commanding regenerative braking to assist in speed control along with the friction brakes, the battery system cannot accept any more energy generated by the regenerative braking. To aid vehicle braking when the electrical system has reached a threshold (e.g., a maximum) potential state of energy, example fluid couplings or torque converters disclosed herein can be used to dissipate mechanical energy by creating a speed differential between the electrical motor and the wheels of the vehicle. To enable heat dissipation, the lock-up clutch of the fluid coupling or torque converter can be opened or set into a state of slip. The electrical motor can then command a negative torque to consume the electrical energy dissipated or lost to the slip in the torque converter while maintaining the set or command speed of the vehicle.

Example slip condition systems disclosed herein can be activated manually (e.g., via a human machine interface or user input) or automatically based on a detected vehicle condition. Example slip condition systems disclosed herein can activate upon detection of a heat request, an energy regeneration mode, and/or any other condition(s).

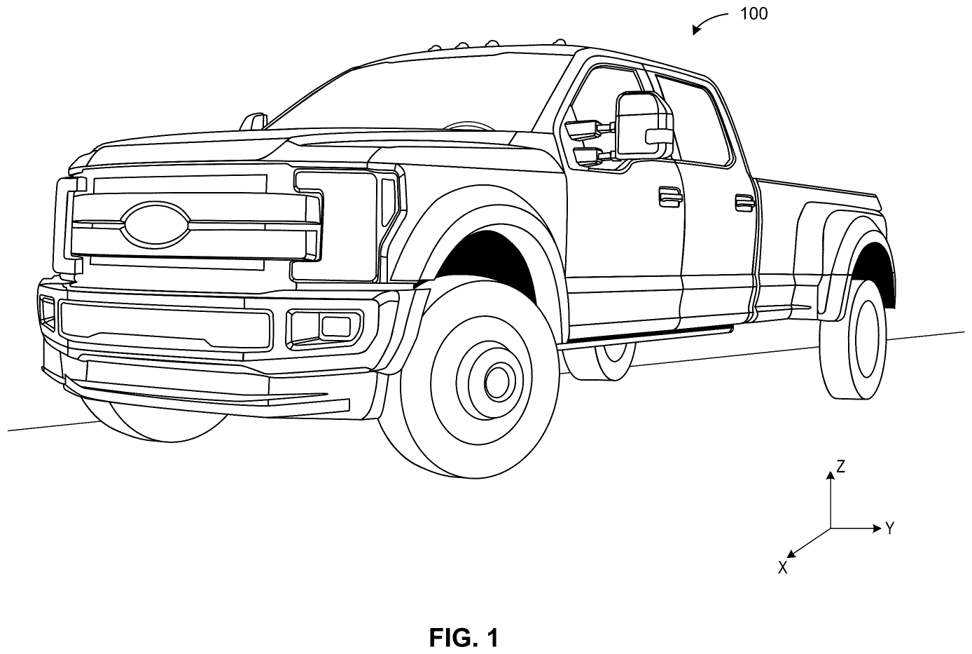

FIG. 1 illustrates an example electric vehicle (EV) 100 in which the teachings of this disclosure can be implemented. In the illustrated example of FIG. 1, the EV 100 is a pick-up truck. In other examples, the EV 100 can be any type of electric vehicle (e.g., a van, a coupe, a sedan, a sport utility vehicle (SUV), a semi-trailer truck, a mini-van, a railed vehicle, an all-terrain vehicle (ATV), etc.). In the illustrated example of FIG. 1, the EV 100 is a two-axle vehicle. Examples disclosed herein are suitable for driven axles (e.g., front axles and/or rear axles).

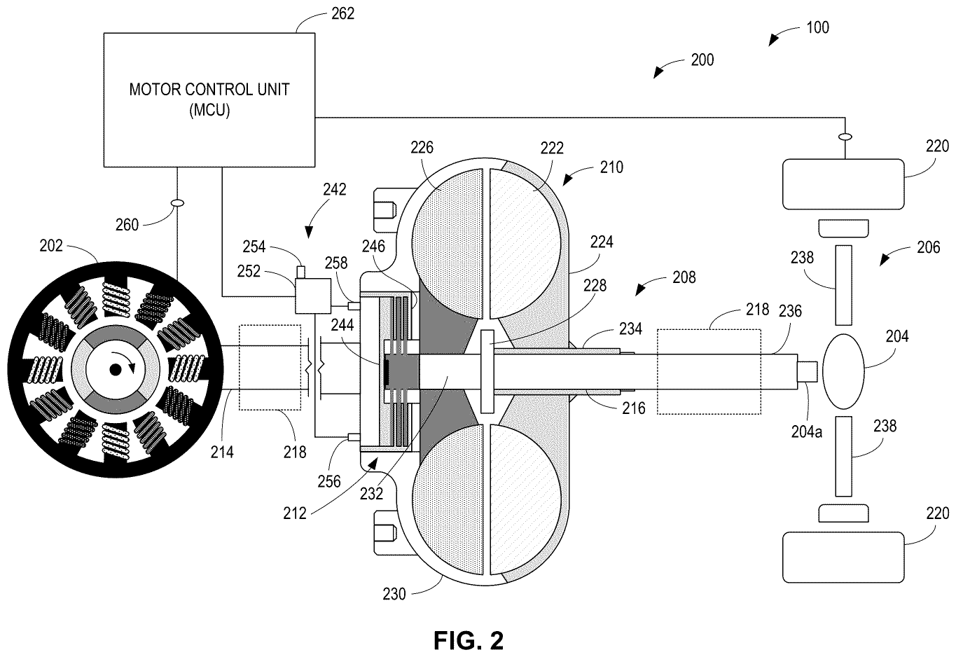

FIG. 2 is a schematic diagram of a portion of an example transmission system 200 of the EV 100 of FIG. 1. The example transmission system 200 of the illustrated example includes an electric motor 202 (e.g., an electric machine) coupled to a differential 204 (e.g., a rear axle or differential) of a drive axle 206 (e.g., a rear axle, a front axle, etc.) via a transmission 208. The electric motor 202 of the illustrated example can be an alternating current (AC) motor (e.g., a three-phase motor), a brushless direct current (BLDC) motor, and/or any other electric motor(s) and/or electric machine(s).

The transmission system 200 of the illustrated example includes a fluid coupling 210 (e.g., a fluid torque converter) and a clutch 212 (e.g., a lock-up clutch). Specifically, the electric motor 202 has an output shaft 214 that is operatively coupled to a drive shaft 216 (e.g., an input shaft) of the transmission 208. The drive shaft 216 provides an input (e.g., input torque and/or speed) to the differential 204. In some examples, the transmission system 200 and/or the transmission 208 of the EV 100 can include a gearbox 218. In some examples, the gearbox 218 can be coupled between the output shaft 214 of the electric motor 202 and the fluid coupling 210. In some examples, the gearbox 218 can be coupled between the fluid coupling 210 and the differential 204. In some examples, the transmission 208 of the illustrated example can include a plurality of gearboxes (e.g., two or more).

The fluid coupling 210 of the illustrated example is a torque converter (e.g., a hydraulic torque converter). For example, the fluid coupling 210 of the illustrated example can be a lock-up torque converter, a multi-passage torque converter (e.g., a two-passage torque converter, a three-passage torque converter, a four-passage torque converter), a high-stall torque converter, and/or any other type of torque converter and/or fluid coupling.

The fluid coupling 210 includes a drive rotor or impeller 222 coupled to a housing 224, a driven rotor or turbine 226, a stator 228 and the clutch 212 (e.g., a lock-out clutch). A front cover 230 is coupled (e.g., fixed, welded, etc.) to the housing 224 to enclose the clutch 212, the impeller 222 and the turbine 226. The front cover 230 and the housing 224 receives or encloses a fluid (e.g., transmission fluid, hydraulic fluid, oil, etc.). The output shaft 214 of the electric motor 202 of the illustrated example is coupled (e.g., fixed) to the front cover 230, which is coupled (e.g., rotatably fixed) to the impeller 222 via the housing 224 (e.g., the front cover 230 is fixed, welded, or fastened to the housing 224). For example, the output shaft 214 of the electric motor 202 can include a plate (e.g., welded or fixed to an end of the output shaft 214) that couples or attaches to the front cover 230 (e.g., via fasteners, welds, etc.). The drive shaft 216 of the illustrated example is coupled to the turbine 226. Specifically, a first end 232 of the drive shaft 216 extends within the housing 224 of the fluid coupling 210 and couples to the turbine 226 (e.g., via a spline connection). Thus, rotation of the output shaft 214 causes rotation of the impeller 222, which causes the fluid within the fluid coupling 210 to rotate the turbine 226 and, thus, rotate the drive shaft 216. The housing 224 of the illustrated example includes a drive hub 234 (e.g., a bushing) to enable the first end 232 of the drive shaft 216 to pass through the housing 224 and/or to enable rotation of the housing 224 and/or the impeller 222 relative to the drive shaft 216. A second end 236 of the drive shaft 216 opposite the first end 232 is coupled (e.g., via a gear such as a bevel gear) to the differential 204 (e.g., an input) of the drive axle 206. The differential 204 includes half-shafts 238 extending from the differential 204 to respective ones of wheels 220 (e.g., rear wheels of the EV 100). In some examples, the drive shaft 216 can be coupled to an input shaft 204a of the differential 204.

During operation of the EV 100, an output torque requirement of the electric motor 202 that exceeds a rotor lock torque (e.g., a maximum torque output) characteristic of the electric motor 202 can cause motor stall when the EV 100 is starting from a standstill position (e.g., vehicle speed is zero). For example, in scenarios where the EV 100 is in a towing mode (e.g., towing a load), an off-road mode, traversing and/or stopped on an inclined grade, and/or otherwise overcoming an obstacle when the EV 100 is starting from a standstill position, a torque requirement to overcome the obstacle can be as much as 3.5 times a torque output of the output shaft and/or the electric motor 202. Such a torque requirement may be greater than the rotor lock torque (e.g., a maximum output torque) of the electric motor 202 associated with a zero vehicle speed.

To overcome rotor lock torque limitations of the electric motor 202, the EV 100 of the illustrated example employs the fluid coupling 210. The fluid coupling 210 enables slip between the output shaft 214 and the drive shaft 216. As a result, the electric motor 202 can be commanded to rotate at a minimum motor speed threshold when the EV 100 is at a standstill position or traveling at low speeds (e.g., less than 5 mph, 10 mph, etc.). For example, the electric motor 202 can operate at a minimum motor speed threshold (e.g., 500 rpm) that enables a maximum torque output of the electric motor 202. The fluid coupling provided by the fluid coupling 210 between the output shaft 214 and the drive shaft 216 enables the output shaft 214 to rotate (e.g., slip) while the drive shaft 216 is in a stall or zero rotational velocity condition. As a result, the fluid coupling 210 enables the output shaft 214 of the electric motor 202 to rotate at a first speed different than a second speed of the drive shaft 216.

To enable slip, the fluid coupling 210 fluidly couples the output shaft 214 and the drive shaft 216. In operation, rotation of the output shaft 214 of the electric motor 202 causes the impeller 222 to rotate via the fluid coupling between the front cover 230 and the housing 224. When the electric motor 202 rotates, it spins or rotates the impeller 222, which in turn sets fluid in the housing 224 in motion. Specifically, centrifugal force moves the fluid toward an outer wall of the housing 224. The fluid then moves through blades of the stator 228 positioned between the impeller 222 and the turbine 226. The stator 228 deflects the fluid flow, thereby increasing a torque delivered to a force output side and/or toward the turbine 226. As the fluid moves from the impeller 222 to the turbine 226 via the stator 228, the fluid generates torque on the turbine 226, causing the turbine 226 and, thus, the drive shaft 216, to rotate thereby providing an input force to the differential 204 which causes rotation of the wheels 220. Additionally, as the fluid moves from the impeller 222 to the turbine 226, the fluid generates heat due to friction.

The torque multiplication effect allows the fluid coupling 210 to increase a torque output from the electric motor 202 enabling enhanced vehicle acceleration and overall performance. This is particularly useful during acceleration and when overcoming resistance, such as when starting from a stop, towing operations, or climbing a hill. Additionally, the fluid coupling 210 enables smooth engagement or transition of power from the electric motor 202 to the transmission 208 or the drive shaft 216. Additionally, torque amplification provided by the fluid coupling 210 reduces loads and/or strain on the electric motor 202, which results in less wear of the electric motor 202 and thereby extending a lifespan of the electric motor 202.

Additionally, the transmission system 200 of the illustrated example bypasses the fluid coupling 210 or employs the fluid coupling 210 based on a condition of the EV 100. Specifically, bypassing the fluid coupling 210 enables the output shaft 214 to be mechanically coupled (e.g., rigidly fixed) to the drive shaft 216 to prevent slip between the output shaft 214 and the drive shaft 216. Enabling or activating the fluid coupling 210 fluidly couples (e.g., mechanically decouples) the output shaft 214 and the drive shaft 216 to allow slip between the output shaft 214 and the drive shaft 216.

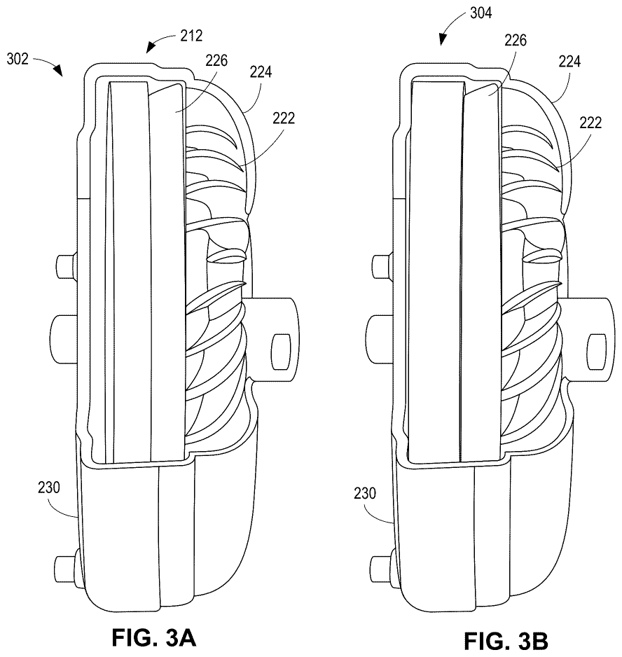

To engage and/or disengage the fluid coupling 210, the transmission system 200 of the illustrated example includes the clutch 212 (e.g., a lock-up clutch). The clutch 212 of the illustrated example is movable between a disengaged position (e.g., a disengaged position 302 of FIG. 3A) and an engaged position (e.g., an engaged position 304 of FIG. 3B). In the disengaged position 302, the clutch 212 mechanically decouples the impeller 222 and the turbine 226. Thus, the output shaft 214 of the electric motor 202 and the drive shaft 216 are fluidly coupled via the fluid coupling 210 (e.g., resulting in torque generation and/or torque amplification as described above) when the clutch is in the disengaged position 302, thereby enabling slip between the output shaft 214 of the electric motor 202 and the drive shaft 216. In this manner, the output shaft 214 of the electric motor 202 rotates at a first speed different than a second speed of the drive shaft 216. In the engaged position 304, the clutch 212 directly or rigidly connects (e.g., mechanically couples) the impeller 222 and turbine 226, effectively bypassing the fluid coupling 210. In this manner, the clutch 212 prevents slip between the output shaft 214 of the electric motor 202 and the drive shaft 216 when the clutch 212 is in the engaged position. As a result, the output shaft 214 and the drive shaft 216 rotate at the same speed. In some examples, the clutch 212 is moved to the engaged position 304 at higher vehicle speeds, thereby improving efficiency and reducing heat generation. Specifically, bypassing the fluid coupling 210 reduces power loss and/or heat generation caused by the fluid connection between the impeller 222 and the turbine 226.

The clutch 212 of the illustrated example is an electronically operated clutch. To control or move the clutch 212 between the disengaged position and the engaged position, the transmission system 200 employs a pressurized fluid system 242. The pressurized fluid system 242 provides or supplies pressurized fluid either to a front surface 244 of the clutch 212 or a rear surface 246 of the clutch 212 opposite the front surface 244. The engagement and disengagement of the clutch 212 depends on a direction of pressurized fluid relative to the clutch 212.

To control the pressurized fluid of the clutch 212, the example pressurized fluid system 242 of the illustrated example includes a main regulator valve 252 that is piloted by a solenoid 254. For example, commanding the solenoid 254 to a first position (e.g., an “on” position) causes the main regulator valve 252 to provide pressurized fluid to the front surface 244 of the clutch 212 (e.g., a clutch disk, a plurality of clutch disks) via a first port 256 of the front cover 230. For example, the solenoid 254 can be energized via a command signal (e.g., a current, an electrical signal, a binary value “1”, etc.) to cause the solenoid 254 to move to the first position. In turn, the pressurized fluid imparts a force to the front surface 244 of the clutch 212 (e.g., the clutch disk) to cause the clutch 212 to move (e.g., axially slide) to the disengaged position 302 (e.g., to cause the clutch 212 to move in a direction away from the front cover 230 to frictionally disengage the front cover 230). In this state, the clutch 212 is in the disengaged position 302 (e.g., an open position), which mechanically decouples from the front cover 230. Thus, when the clutch 212 is the disengaged position 302, the clutch 212 causes the output shaft 214 and the drive shaft 216 to be fluidly coupled (e.g., mechanically decoupled) via the fluid coupling 210.

In contrast, commanding the solenoid 254 to a second position (e.g., an “off” position) causes the main regulator valve 252 to direct pressurized fluid to the rear surface 246 of the clutch 212 via a second port 258 of the front cover 230. For example, the solenoid 254 can be switched off via a command signal (e.g., removing a current, a binary value “0,” etc.) to cause the solenoid 254 to move to the second position. In turn, the increased pressure causes the clutch 212 to move (e.g., axially slide) toward the front cover 230 to engage (e.g., frictionally engage) with the front cover 230. The clutch 212, being coupled to the turbine 226, causes the turbine 226 to rotate with the front cover 230, the housing 224 and the impeller 222 when the clutch 212 is in the engaged position 304 (e.g., the clutch 212 is in frictional engagement with the front cover 230). In the engaged position 304, the clutch 212 mechanically couples the output shaft 214 and the drive shaft 216. When the clutch 212 is in the engaged position 304, the impeller 222 is mechanically coupled to the turbine 226 and power from the electric motor 202 is transferred to the transmission 208 without power losses caused by the fluid coupling 210. Additionally, the clutch 212 of the illustrated example includes dampening springs that absorb torsional vibrations during clutch engagement/disengagement to prevent or reduce shock transfer to the transmission 208.

To control a state of the clutch 212, a motor control unit (MCU) 262 (e.g., MCU circuitry) of the EV 100 receives or otherwise obtains one or more signals (e.g., feedback signals) from one or more sensors 260. For example, the MCU 262 controls the motor speed and/or the torque output of the electric motor 202. The one or more sensors 260 can include a tachometer(s), a magnetic sensor(s) (e.g., a hall effect sensor(s)), inductive sensor(s), a temperature sensor(s), current sensor(s), an encoder(s), a resolver(s), a camera(s), an imaging sensor(s), an accelerometer(s), a trailer light detection sensor(s) and/or any other sensor(s). For example, hall effect sensors, encoders, resolvers, etc. can be used to detect a speed of the output shaft 214 of the electric motor 202. Torque output is proportional to magnetic flux, which is proportional to current. Thus, torque output of the electric motor 202 can be derived by measuring current flowing to a motor inverter drive.

FIG. 3A is a partial cutaway, side view of the example fluid coupling 210 of FIG. 2 with the clutch in an example disengaged position 302. FIG. 3B is a partial cutaway, side view of the example fluid coupling 210 of FIG. 3A with the clutch in an example engaged position 304. Referring to FIGS. 3A-3B, the clutch 212 slides in an axial direction relative to the front cover 230 via the pressure system to move the clutch 212 between the engaged position 304 and the disengaged position 302.

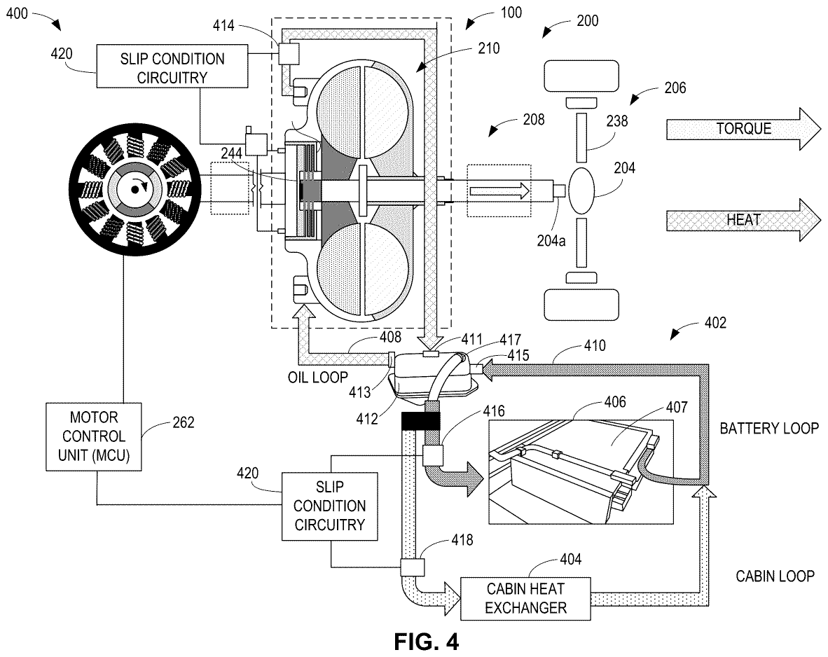

FIG. 4 is a schematic diagram of a slip condition system 400 of the EV 100 of FIG. 1. In the illustrated example of FIG. 4, the slip condition system 400 includes a heat distribution system 402. The heat distribution system 402 of the illustrated example transfers heat from a first fluid (e.g., oil) of the fluid coupling 210 to another area and/or component of the EV 100. In this example, the heat distribution system 402 causes heat from the first fluid to be transferred to a second fluid (e.g., glycol) associated with an environmental control system of the EV 100. Further, the heat distribution system 402 can direct and/or guide the second fluid (e.g., glycol) to transmit the heat to a cabin heat exchanger 404 or a cabin of the EV 100, a battery heat exchanger 406 or a battery pack of the EV 100, and/or another heat exchanger(s) that supports an operation of the EV 100.

In the illustrated example of FIG. 4, the heat distribution system 402 includes a first fluid conduit 408 (e.g., first closed loop passageway) to carry the first fluid, a second fluid conduit 410 (e.g., a second closed loop passageway) to carry the second fluid, and a heat exchanger 412 to facilitate the transfer of heat from the first fluid (e.g., the oil of the fluid coupling 210) to the second fluid (e.g., glycol). Accordingly, the heat exchanger 412 is operatively coupled to the first fluid conduit 408 and the second fluid conduit 410. In turn, the heat exchanger 412 thermally couples the first fluid to the second fluid. In this example, the heat exchanger 412 of the illustrated example is a liquid-to-liquid heat exchanger. However, in other examples, the heat exchanger 412 can be, for example, a fluid-to-fluid heat exchanger, a liquid-to-liquid heat exchanger, a shell and tube heat exchanger, a plate heat exchanger, a brazed plate heat exchanger, a round-tube-fin (RTPF) heat exchanger, a microchannel heat exchanger and/or any other type of heat exchanger(s).

The first fluid conduit 410 defines a first loop (e.g., a first closed loop, an oil loop) that carries the first fluid between the heat exchanger 412 and a chamber of the fluid coupling 210. The second fluid conduit 410 defines a second loop (e.g., a second closed loop, a cabin loop) that carries the second fluid in a loop between the heat exchanger 412 and the cabin heat exchanger 404. Additionally, the second fluid conduit 410 defines a third loop (e.g., a third closed loop, a battery loop) that carries the second fluid between the heat exchanger 412 and the battery heat exchanger 406.

In the illustrated example of FIG. 4, the heat exchanger 412 includes a first inlet 411 and a first outlet 413 through which the first fluid flows. In this example, the heat exchanger 412 includes a second inlet 415 and a second outlet 417 through which the second fluid flows. In some examples, the heat exchanger 412 includes one or more additional inlets and/or outlets for the second fluid. For example, the second fluid conduit 410 can have separate loops to carry the second fluid from the heat exchanger 412 to the cabin heat exchanger 404, the battery heat exchanger 406, and/or another heat exchanger(s) that supports an operation of the EV 100, respectively. In such examples, the heat exchanger 412 can have respective inlets and/or outlets designated for the respective loops. In some examples, the heat distribution system 402 can include a fluid-to-fluid heat exchanger (e.g., a fluid-to-ambient air) such that heat air is provided to the cabin of the vehicle via a blower (e.g., fan) blowing air through the heat exchanger. The fluid-to-fluid heat exchanger can be used in place of, or in addition to, the heat exchanger 412.

In the illustrated example of FIG. 4, the heat distribution system 402 includes a first fluid valve 414 (e.g., a first control valve) to control a flow of the first fluid in the first or oil loop, a second fluid valve 416 (e.g., a second control valve) to control a flow of the second fluid in the second or battery loop, and a third fluid valve 418 (e.g., a third control valve) to control a flow of the second fluid in the third or cabin loop. In some examples, the heat distribution system 402 includes a fluid pump operatively coupled to the second fluid conduit 410 to drive the second fluid through the respective loops.

To control operation of the slip condition system 400 and/or the heat distribution system 402, the EV 100 of the illustrated example includes slip condition circuitry 420. Specifically, the slip condition circuitry 420 is communicatively coupled with the MCU 262, which controls operation of the fluid coupling 210. Additionally, the slip condition circuitry 420 is communicatively coupled to the fluid valves 414, 416, 418 to control heat transfer between the first fluid and the second fluid. In operation, the slip condition circuity 420 detects a slip condition request from the MCU 262. The request can be, for example, an amount of energy (e.g., a value in watts) associated with applying sufficient heat to the cabin and/or battery of the EV 100. For example, the amount of energy requested is associated with an amount of heat generated by the operation of the fluid coupling 210. In some examples, the request can be, for example, an amount of energy (e.g., a value in watts) associated with dissipating energy generated during a regenerative braking condition when, for example, a capacity of the battery is greater than a capacity threshold and/or a temperature of the battery is less than a temperature threshold.

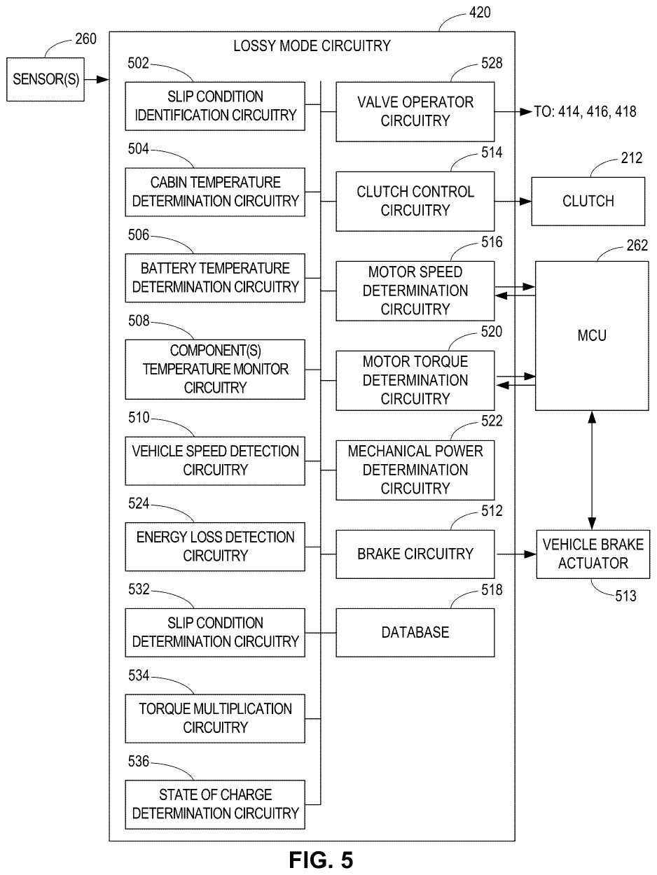

FIG. 5 is a block diagram of an example implementation of the slip condition circuitry 420 of FIG. 4. The slip condition circuitry 420 operates and/or instructs the MCU 262 to operate the electric motor 202, the fluid coupling 210, and/or the fluid valves 414, 416, 418 based on detected conditions of the EV 100. The slip condition circuitry 420 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the slip condition circuitry 420 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example slip condition circuitry 420 of FIG. 5 includes example slip condition identification circuitry 502, example cabin temperature determination circuitry 504, example battery temperature determination circuitry 506, example component temperature monitor circuitry 508, example vehicle speed detection circuitry 510, example brake circuitry 512, example clutch control circuitry 514, motor speed determination circuitry 516, an example database 518, example motor torque determination circuitry 520, example mechanical power determination circuitry 522, example energy loss detection circuitry 524, example valve operator circuitry 528, example slip determination circuitry 532, example torque multiplication circuitry 534, and example state of charge determination circuitry 536.

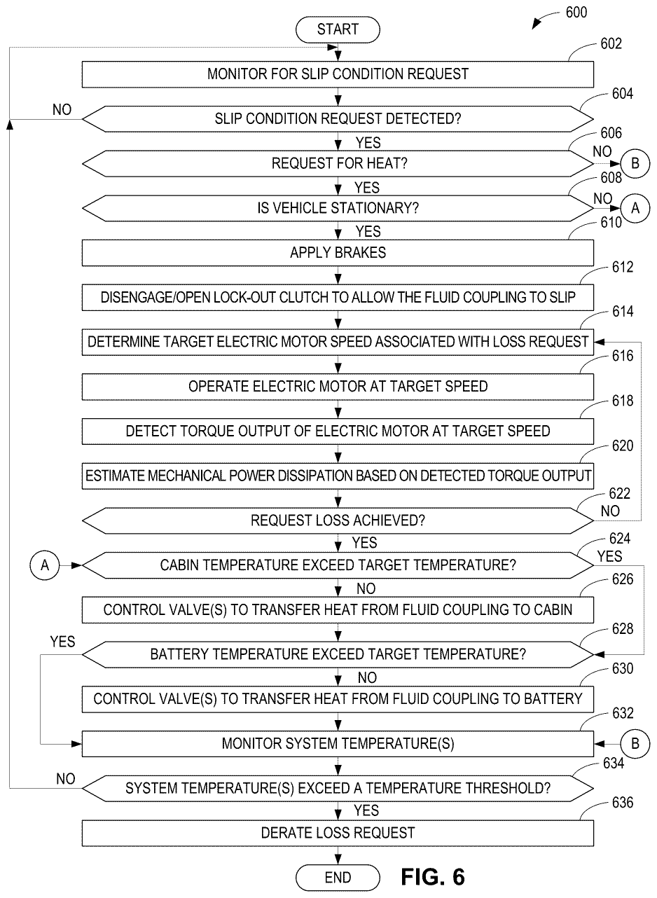

The example slip condition identification circuitry 502 detects a torque converter or fluid coupling slip condition request. For example, the slip condition identification circuitry 502 can distinguish and/or detect between at least one of a slip condition request for heat associated with a heating event or energy dissipation associated with a regenerative braking event. In some examples, the slip condition identification circuitry 502 receives a slip condition request based on a command provided by the MCU 262. In some examples, the slip condition identification circuitry 502 detects a slip condition request based on information provided by the sensors 260, a user input (e.g., a human-machine interface such as a cabin heat user input), the MCU 262, and/or any other system(s) of the EV 100. In some examples, the slip condition identification circuitry 502 can trigger slip condition operations based on, for example, a temperature of the battery of the EV 100, a temperature condition of one or more portions of the cabin of the EV 100, a regeneration request from the MCU 262, and/or any other vehicle condition(s). In other examples, the slip condition identification circuitry 502 can include and/or be in communication with other circuitry for detecting and/or generating a slip condition request for the EV 100. For example, the slip condition identification circuitry 502 can trigger the slip condition operations in response to receiving a signal (e.g., an electrical signal, a pneumatic signal, etc.) received from another component (e.g., the MCU 262) indicative of a slip condition request. The slip condition request and/or the slip condition information that the slip condition identification circuitry 502 determines a slip condition event can include a power amplitude associated with a loss to be encountered by the electric motor 202. For example, the slip condition request can be 3 kilowatts (kW) of loss. In some examples, the slip condition identification circuitry 502 determines the magnitude of the loss based on an amount of heat to be utilized to heat the cabin and/or the battery of the EV 100. In some examples, the slip condition identification circuitry 502 determines the magnitude of the loss based on a difference between a temperature of the electric motor 202 and a target temperature range. In some examples, the slip condition identification circuitry 502 is instantiated by programmable circuitry executing slip condition identification instructions and/or configured to perform operations such as those represented by the flowchart of FIG. 6.

The example cabin temperature determination circuitry 504 identifies a temperature of one or more portions of the cabin of the EV 100 based on information from the sensors 260. Additionally, the cabin temperature determination circuitry 504 can identify a target temperature(s) (e.g., a cabin command temperature, a cabin temperature threshold) associated with the one or more portions of the cabin based on information from the sensors 260, a user input, and/or intended operating parameters. The cabin temperature determination circuitry 504 can compare the identified temperature(s) to the corresponding target temperature(s). The cabin temperature determination circuitry 504 can indicate a difference between the identified temperature(s) and the corresponding target temperature(s) to the slip condition identification circuitry 502 and/or the valve operator circuitry 528. In some examples, the cabin temperature determination circuitry 504 is instantiated by programmable circuitry executing cabin temperature determination instructions and/or configured to perform operations such as those represented by the flowchart of FIG. 6.

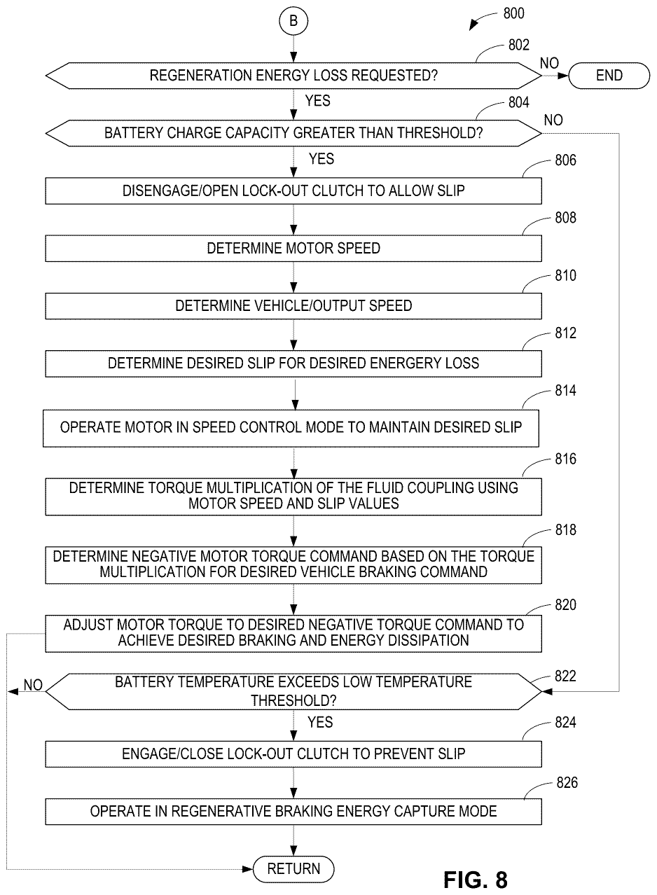

The example battery temperature determination circuitry 506 identifies, determines, and/or otherwise obtains a temperature of a battery system of the EV 100 based on information from the sensors 260 (e.g., a battery system temperature). The battery temperature determination circuitry 506 can determine a battery temperature threshold based on information stored in the database 518. For example, the battery temperature threshold can be predetermined based on a lower temperature limit at which the battery of the EV 100 is intended to operate. The battery temperature determination circuitry 506 can compare the identified temperature and the battery temperature threshold to determine whether the battery temperature exceeds the temperature threshold (e.g., determine whether to supply heat to the battery). The battery temperature determination circuitry 506 can communicate the determined temperature difference between the identified temperature and the battery temperature threshold(s) to the slip condition identification circuitry 502 and/or the valve operator circuitry 528. In some examples, the battery temperature determination circuitry 506 is instantiated by programmable circuitry executing battery temperature determination instructions and/or configured to perform operations such as those represented by the flowcharts of FIGS. 6 and 8.

The example vehicle speed detection circuitry 510 determines a speed of the EV 100 based on information from the sensors 260, the MCU 262, and/or any other component(s) or circuitry. Accordingly, the vehicle speed detection circuitry 510 can determine whether the EV 100 is stationary. Additionally, the vehicle speed detection circuitry 510 can determine a vehicle command speed associated with a user input and/or an assisted driving system or circuitry. In some examples, the vehicle speed detection circuitry 510 is instantiated by programmable circuitry executing vehicle speed detection instructions and/or configured to perform operations such as those represented by the flowchart of FIG. 6.

The example brake circuitry 512 controls a vehicle brake actuator 513. Accordingly, the brake circuitry 512 can cause the vehicle brake actuator 513 to apply brakes (e.g., a foot brake system and/or emergency brakes) to wheels of the EV 100 when the EV 100 is to remain stationary during certain slip condition operations. In some examples, the brake circuitry 512 is instantiated by programmable circuitry executing brake instructions and/or configured to perform operations such as those represented by the flowchart of FIG. 6.

The example clutch control circuitry 514 commands, instructs and/or otherwise controls a position of the lock-out clutch 212 and, thus, an engagement state of the fluid coupling 210. For example, the clutch control circuitry 514 can cause the MCU 262 to command the pressurized fluid system 242 to disengage/open the lock-out clutch 212 to facilitate slip between the output shaft 214 and the drive shaft 216. In some examples, the clutch control circuitry 514 is instantiated by programmable circuitry executing clutch operator instructions and/or configured to perform operations such as those represented by the flowcharts of FIGS. 6-8.

The motor speed determination circuitry 516 determines, receives, and/or otherwise obtains a motor speed output of the electric motor 202. For example, the motor speed determination circuitry 516 receives motor speed values from the MCU 262 and/or one or more sensors 260 (e.g., hall effect sensors, encoders, resolvers) employed to detect a speed of the output shaft 214 of the electric motor 202. In some examples, the motor speed determination circuitry 516 determines a speed at which the electric motor 202 is to operate to obtain a desired loss associated with a slip condition request. In such examples, the motor speed determination circuitry 516 causes the MCU 262 to operate the electric motor 202 at the target speed. For example, the motor speed determination circuitry 516 can determine the motor speed based on a desired slip and a vehicle command speed. In some examples, the motor speed determination circuitry 516 determines the motor speed based on (i) a speed of the drive shaft 216 associated with the vehicle command speed and (ii) a difference between a speed of the output shaft 214 and the speed of the drive shaft 216 that provides the desired slip. The database 518 can include a mapping or correlation of loss request values (e.g., in units of power) and motor speeds (e.g., in units of RPMs) needed to achieve the loss requirements. As such, the motor speed determination circuitry 516 can determined a motor speed linked to a corresponding requested energy loss (e.g., provided in units of power). In some examples, the motor speed determination circuitry 516 is instantiated by programmable circuitry executing motor speed determination instructions and/or configured to perform operations such as those represented by the flowcharts of FIGS. 6-8.

The example motor torque determination circuitry 520 determines, receives, and/or otherwise obtains motor torque output of the electric motor 202. For example, the motor torque determination circuitry 520 can receive motor torque values from the MCU 262. In some examples, the motor torque determination circuitry 520 calculates a motor torque output by the electric motor 202 based on a measured current drawn by the electric motor 202. In some examples, the motor torque determination circuitry 520 determines a torque command provided by a user of the EV 100. For example, the torque command values are provided by a user's interaction with a pedal of the EV 100.

Further, the motor torque determination circuitry 520 can determine the torque output of the electric motor 202 when the EV 100 is operating in the slip condition. For example, the motor torque determination circuitry 520 can determine the torque output for the electric motor 202 based on a vehicle command speed and a torque multiplication of the fluid coupling 210. To operate the motor at the desired motor torque, the motor torque determination circuitry 520 can cause the MCU 262 to adjust a voltage or a frequency of an electronic signal supplied to the electric motor 202. In some examples, the motor torque determination circuitry 520 is instantiated by programmable circuitry executing motor torque determination instructions and/or configured to perform operations such as those represented by the flowcharts of FIGS. 6-8.

The example mechanical power determination circuitry 522 estimates a mechanical power dissipation (e.g., in Watts) associated with slip condition operations based on the detected rotational speed of the electric motor 202 and/or the detected torque output by the electric motor 202. In some examples, the mechanical power determination circuitry 522 causes the motor speed determination circuitry 516 and/or the motor torque determination circuitry 520 to adjust the speed and/or torque of the electric motor 202 based on a difference between the estimated power dissipation and the requested loss associated with the slip condition request. In some examples, the mechanical power determination circuitry 522 is instantiated by programmable circuitry executing mechanical power determination instructions and/or configured to perform operations such as those represented by the flowchart of FIG. 6.

The example energy loss detection circuitry 524 determines whether a requested loss has been achieved via the slip condition operations. For example, the energy loss detection circuitry 524 can determine whether the estimated mechanical power dissipation is approximately equivalent to (e.g., within 10% of) the requested loss. In some examples, the energy loss detection circuitry 524 is instantiated by programmable circuitry executing energy loss detection instructions and/or configured to perform operations such as those represented by the flowchart of FIG. 6.

The example valve operator circuitry 528 controls respective positions of the first fluid valve 414, the second fluid valve 416, and the third fluid valve 418. For example, the valve operator circuitry 528 can control the first fluid valve 414 and/or the third fluid valve 418 to cause the first fluid associated with the fluid coupling 210 to transfer heat to the second fluid associated with heating the cabin. In some examples, the valve operator circuitry 528 controls a rate at which the first fluid transfers heat to the second fluid. For example, the valve operator circuitry 528 can determine a position to be implemented by the first fluid valve 414 and/or a position to be implemented by the third fluid valve 418 based on the target temperature, the temperature of the cabin, a temperature of the first fluid at an inlet of the cabin heat exchanger 404, and/or a temperature of the second fluid at an outlet of the cabin heat exchanger 404. Further, the valve operator circuitry 528 can determine a position to be implemented by the second fluid valve 416 and/or a position to be implemented by the third fluid valve 418 based on the battery temperature threshold, the temperature of the battery, a temperature of the first fluid at an inlet of the battery heat exchanger 406, and/or a temperature of the second fluid at an outlet of the battery heat exchanger 406. In some examples, the valve operator circuitry 528 controls a rate at which the first fluid transfers heat to the second fluid. For example, the valve operator circuitry 528 can determine a position to be implemented by the first fluid valve 414 and/or a position to be implemented by the third fluid valve 418 based on the target temperature, the temperature of the cabin, a temperature of the first fluid at an inlet of the cabin heat exchanger 404, and/or a temperature of the second fluid at an outlet of the cabin heat exchanger 404. Further, the valve operator circuitry 528 can determine a position to be implemented by the second fluid valve 416 and/or a position to be implemented by the third fluid valve 418 based on the battery temperature threshold, the temperature of the battery, a temperature of the first fluid at an inlet of the battery heat exchanger 406, and/or a temperature of the second fluid at an outlet of the battery heat exchanger 406. In some examples, the valve operator circuitry 528 is instantiated by programmable circuitry executing valve operator instructions and/or configured to perform operations such as those represented by the flowchart of FIG. 6.

The example component temperature monitor circuitry 508 monitors component temperatures to determine whether one or more component(s) associated with the slip condition request are within operating temperature threshold(s). For example, the component temperature monitor circuitry 508 can monitor a temperature of the electric motor 202, the fluid coupling 210, the battery, and/or other component(s) of the EV 100 during slip condition based on information from the sensors 260 and/or other components of the slip condition circuitry 420. Further, the component temperature monitor circuitry 508 can determine whether the temperature of the electric motor 202, the fluid coupling 210, the battery, and/or another component of the EV 100 exceeds a temperature threshold associated with the respective component. For example, the component temperature monitor circuitry 508 determines if the electric motor 202 is operating at a temperature that exceeds a motor operating temperature threshold. In some examples, the component temperature monitor circuitry 508 determines if the fluid coupling 210 is operating at a temperature that exceeds an operating temperature threshold of the fluid coupling 210. In some examples, the component temperature monitor circuitry 508 determines if a battery temperature is greater than an upper temperature threshold or if a battery temperature is less than a lower temperature threshold. Additionally, in some examples, the component temperature monitor circuitry 508 can instruct, command, and/or otherwise cause the slip condition identification circuitry 502, the slip condition circuitry 420 and, more generally, the MCU 262 to derate the slip condition if the component temperatures are not within satisfactory operating temperature limits or thresholds. The component temperature monitor circuitry 508 can retrieve or otherwise obtain component temperature threshold values from the database 518. In some examples, the component temperature monitor circuitry 508 is instantiated by programmable circuitry executing system temperature monitor instructions and/or configured to perform operations such as those represented by the flowchart of FIG. 6.

The example slip determination circuitry 532 determines a desired slip for the fluid coupling 210 (e.g., between the output shaft 214 and the drive shaft 216) to obtain a desired energy loss associated with the slip condition request. For example, the slip determination circuitry 532 can determine the desired slip to obtain a desired energy loss associated with the slip condition request based on the information from the sensors 260 and/or the MCU 262. In some examples, the slip determination circuitry 532 determines the desired slip for the slip condition request via a loss-to-slip lookup table in the database 518. In some examples, the slip determination circuitry 532 is instantiated by programmable circuitry executing slip determination instructions and/or configured to perform operations such as those represented by the flowcharts of FIGS. 6-8.

The example torque multiplication circuitry 534 determines a torque multiplication of the fluid coupling 210 based on the determined motor speed and the desired slip between the output shaft 214 and the drive shaft 216 associated with obtaining the requested loss. In some examples, the torque multiplication circuitry 534 identifies the torque multiplication based on information from the sensors 260 and/or the MCU 262. In some examples, the torque multiplication circuitry 534 is instantiated by programmable circuitry executing torque multiplication instructions and/or configured to perform operations such as those represented by the flowcharts of FIGS. 6-8.

The example state of charge determination circuitry 536 determines whether a state of charge of the battery of the EV 100 is greater than a charge status threshold (e.g., a charge threshold, a charge capacity threshold). For example, the state of charge determination circuitry 536 can determine whether the state of charge of the battery of the EV 100 is greater than the charge status threshold (e.g., 98%, 95%, 90%, etc.). In some examples, the state of charge determination circuitry 536 is instantiated by programmable circuitry executing state of charge determination instructions and/or configured to perform operations such as those represented by the flowchart of FIG. 8.

While an example manner of implementing the slip condition circuitry 420 of FIG. 4 is illustrated in FIG. 5, one or more of the elements, processes, and/or devices illustrated in FIG. 5 may be combined, divided, re-arranged, omitted, eliminated, and/or implemented in any other way. Further, the example ... and/or, more generally, the example slip condition circuitry 420 of FIG. 5, may be implemented by hardware alone or by hardware in combination with software and/or firmware. Thus, for example, any of the example slip condition identification circuitry 502, the example cabin temperature determination circuitry 504, the example battery temperature determination circuitry 506, the example component temperature monitor circuitry 508, the example vehicle speed detection circuitry 510, the example brake circuitry 512, the example clutch control circuitry 514, the example motor speed determination circuitry 516, the example database 518, the example motor torque determination circuitry 520, the example mechanical power determination circuitry 522, the example energy loss detection circuitry 524, the example valve operator circuitry 528, the example slip determination circuitry 532, the example torque multiplication circuitry 534, and the example regeneration braking circuitry 536 and/or, more generally, the example slip condition circuitry 420 of FIG. 5, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example slip condition circuitry 420 of FIG. 5 may include one or more elements, processes, and/or devices in addition to, or instead of, those illustrated in FIG. 5, and/or may include more than one of any or all of the illustrated elements, processes, and devices.

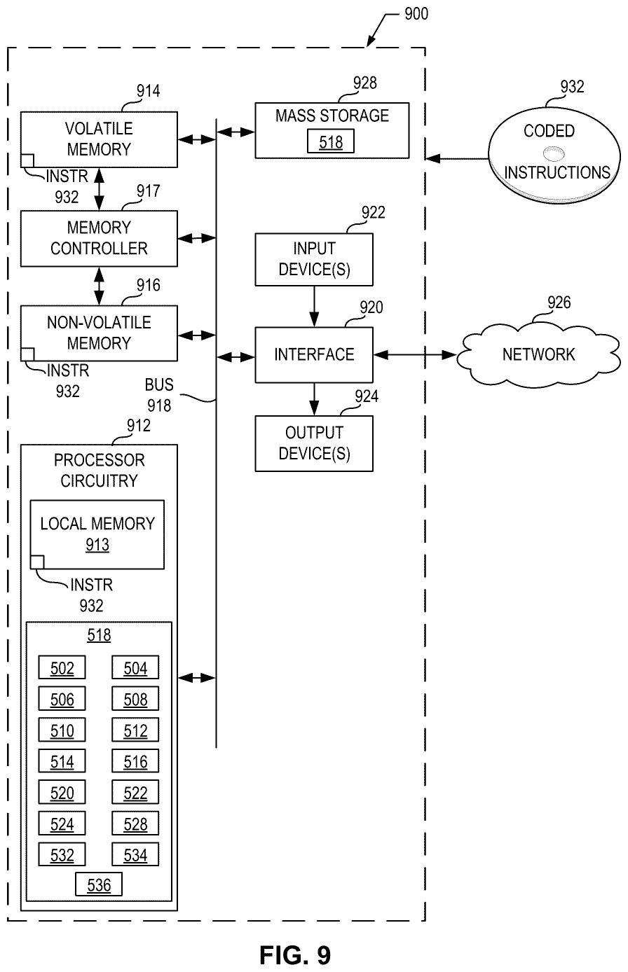

Flowcharts representative of example machine readable instructions, which may be executed by programmable circuitry to implement and/or instantiate the example slip condition circuitry 420 of FIG. 5 and/or representative of example operations which may be performed by programmable circuitry to implement and/or instantiate the example slip condition circuitry 420 of FIG. 5, are shown in FIGS. 6-8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry. In some examples, the machine readable instructions cause an operation, a task, etc., to be conducted and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 6-8, many other methods of implementing the example slip condition circuitry 420 of FIG. 5 may alternatively be used. For example, the order of execution of the blocks of the flowcharts may be changed, and/or some of the blocks described may be changed, eliminated, duplicated, or combined. Additionally or alternatively, any or all of the blocks of the flow chart may be implemented by one or more hardware circuits (e.g., processor circuitry, discrete and/or integrated analog and/or digital circuitry, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or RAID systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by example programmable circuitry to facilitate heat transfer and/or energy dissipation in the EV 100. The heat transfer and/or energy dissipation can help the EV 100 operate more efficiently and/or increase a lifespan of vehicular components, such as the electric motor 202.

The example machine-readable instructions and/or the example operations 600 of FIG. 6 begin at block 602, at which the example slip condition circuitry 420 monitors for a slip condition (e.g., an energy loss or dissipation request). For example, the slip condition identification circuitry 502 of the slip condition circuitry 420 can monitor for a slip condition request (e.g., from the ECU). Additionally or alternatively, the slip condition identification circuitry 502 can determine that the slip condition is to be triggered based on information from the sensors 260 and/or the MCU 262.

At block 604, the slip condition circuitry 420 determines whether a slip condition has been detected. When the slip condition has been detected, the operations 600 proceed to block 606. Otherwise, when slip condition has not been detected at block 604, the operations 600 return to block 602.

At block 606, the slip condition circuitry 420 determines whether the slip condition request is for heat. For example, the slip condition identification circuitry 502 can determine whether the slip condition operations are intended to heat a component and/or area of the EV 100, such as the battery and/or the cabin of the EV 100, or energy dissipation based on a regenerative braking event or condition. When the slip condition request is at least partially for heat, the operations 600 proceed to block 608. Otherwise, when the slip condition request is for energy dissipation, the operations 600 proceed to flowchart B and operations 800 of FIG. 8.

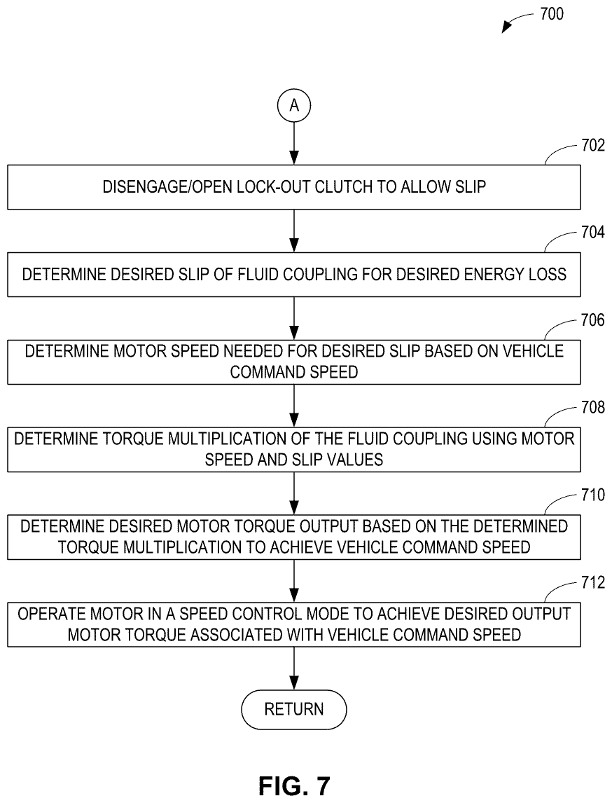

At block 608, the slip condition circuitry 420 determines whether the EV 100 is stationary. For example, the vehicle speed detection circuitry 510 can determine whether the EV 100 is stopped and/or parked. if the vehicle speed detection circuitry 510 determines that the EV 100 is stationary at block 608, the operations 600 proceed to block 610. Otherwise, if the vehicle speed detection circuitry 510 determines that the EV 100 is not stationary at block 608, the operations 600 proceed to flowchart A and operations 700 of FIG. 7.

At block 610, the slip condition circuitry 420 applies the brake (e.g., an emergency brake, a foot brake, etc.) so that the EV 100 remains stationary during the slip condition event. For example, when the slip condition is utilized while the EV 100 is stationary (e.g., to pre-heat an area and/or component of the EV 100), the brake circuitry 512 causes a vehicle brake actuator 513 to apply the brakes of the EV 100, if not already applied, and, thus, maintain the stationary state of the EV 100.

At block 612, the slip condition circuitry 420 disengages/opens the lock-out clutch 212 to allow the fluid coupling 210 to slip (e.g., a slip condition). For example, the clutch control circuitry 514 can cause the pressurized fluid system 242 to disengage/open the lock-out clutch 212 to facilitate slip between the output shaft 214 and the drive shaft 216.

At block 614, the slip condition circuitry 420 determines a target electric motor speed associated with the energy loss of slip condition request. For example, the motor speed determination circuitry 516 can determine a speed at which the electric motor 202 is to operate (e.g., in rotations per minute (RPM)) to obtain the desired energy loss to generate sufficient heat for the heat distribution system 402. For example, the database 518 can include a mapping of electric motor speeds to corresponding energy loss request values. As such, the motor speed determination circuitry 516 can retrieve and/or otherwise obtain the target electric motor speed from the database 518.

At block 616, the slip condition circuitry 420 causes the electric motor 202 to operate at the target speed. For example, the motor speed determination circuitry 516 can instruct the MCU 262 to operate the electric motor 202 at the target speed.

At block 618, the slip condition circuitry 420 detects a torque output of the electric motor 202 at the target speed. For example, the motor torque determination circuitry 520 determines, receives, and/or otherwise obtains motor torque output of the electric motor 202. For example, the motor torque determination circuitry 520 can receive motor torque values from the MCU 262. In some examples, the motor torque determination circuitry 520 calculates motor torque output by the electric motor 202 based on a measured current drawn by the electric motor 202.

At block 620, the slip condition circuitry 420 estimates a mechanical power dissipation based on the detected torque output. For example, the mechanical power determination circuitry 522 can estimate the mechanical power dissipation (e.g., in Watts) based on a rotational speed of the electric motor 202 and the detected torque output.

At block 622, the slip condition circuitry 420 determines whether the requested loss has been achieved. For example, the energy loss detection circuitry 524 can determine whether the estimated mechanical power dissipation is approximately equivalent to (e.g., within 10% of) the energy dissipation value associated with the slip condition request. That is, the energy loss detection circuitry 524 determines if the requested energy loss has been achieved when the estimated power dissipation is approximately equivalent to the requested energy loss. If the energy loss detection circuitry 524 determines that the requested energy loss has been achieved at block 622, the operations 600 proceed to block 624. If the energy loss detection circuitry 524 determines that the requested energy loss has not yet been achieved at block 622, the operations 600 return to block 614

At block 624, the slip condition circuitry 420 determines whether a cabin temperature associated with the EV 100 exceeds a target temperature. For example, the cabin temperature determination circuitry 504 can identify a temperature of a cabin of the EV 100, or a particular portion of the cabin, based on information from the sensors 260. Additionally, the cabin temperature determination circuitry 504 can identify a target temperature associated with the cabin or portion thereof based on information from the sensors 260. For example, the information from the sensors 260 can convey an input from a user indicative of the target temperature. If at block 624 the cabin temperature determination circuitry 504 determines that the cabin temperature exceeds the target temperature, the operations 600 skip to block 628. Otherwise, If at block 624 the cabin temperature determination circuitry 504 determines that the cabin temperature does not exceed the target temperature, the operations 600 proceed to block 626.

At block 626, the slip condition circuitry 420 controls the first fluid valve 414 and/or the third fluid valve 418 to transfer heat from the fluid coupling 210 to the cabin of the EV 100. For example, the valve operator circuitry 528 can control the first fluid valve 414 and/or the third fluid valve 418 to cause the first fluid associated with the fluid coupling 210 to transfer heat to a second fluid associated with heating the cabin.

At block 628, the slip condition circuitry 420 determines whether a battery temperature exceeds a battery temperature threshold. For example, the battery temperature threshold can be predetermined based on a lower temperature limit at which the battery of the EV 100 can operate. The battery temperature determination circuitry 506 can determine the battery temperature based on information from the sensors 260. If at block 638 the battery temperature determination circuitry 506 determines that the battery temperature does not exceed the battery temperature threshold, the operations 600 proceed to block 630. Otherwise, If at block 638 the battery temperature determination circuitry 506 determines that the battery temperature exceeds the battery temperature threshold, the operations 600 skip to block 632.

At block 630, the slip condition circuitry 420 controls the second fluid valve 416 and/or the third fluid valve 418 to transfer heat from the fluid coupling 210 to the battery of the EV 100. For example, the slip condition circuitry 420 can control the second fluid valve 416 and/or the third fluid valve 418 to cause the first fluid associated with the fluid coupling 210 to transfer heat to a second fluid associated with heating the battery.

At block 632, the slip condition circuitry 420 monitors a system temperature(s). For example, via the sensors 260, the component temperature monitor circuitry 508 can monitor a temperature of the electric motor 202, the fluid coupling 210, the battery, and/or another component of the EV 100 that receives heat when the EV 100 is operating in the slip condition.

At block 634, the slip condition circuitry 420 determines whether the system temperature(s) exceed a temperature threshold(s). For example, the component temperature monitor circuitry 508 can determine whether the temperature of the electric motor 202, the fluid coupling 210, the battery, and/or another component of the EV 100 exceeds a temperature threshold associated with the respective component. If at block 634 the component temperature monitor circuitry 508 determines that the system temperature(s) exceed the temperature threshold(s), the operations 600 proceed to block 636. Otherwise, if at block 634 the component temperature monitor circuitry 508 determines that the component temperature(s) do not exceed the temperature threshold(s), the operations 600 return to block 602.

At block 636, the slip condition circuitry 420 derates the loss request. For example, the motor speed determination circuitry 516 can reduce a target speed for the electric motor 202 to reduce a temperature of the electric motor 202, the fluid coupling 210, and/or the first fluid.

FIG. 7 is a flowchart representative of example machine readable instructions and/or example operations 700 that may be executed, instantiated, and/or performed by example programmable circuitry to facilitate vehicle operations that perform a slip condition request associated with a heat request when the EV 100 is moving (i.e., not stationary). The example machine-readable instructions and/or the example operations 700 of FIG. 7 begin at block 702, at which the slip condition circuitry 420 disengages/opens the lock-out clutch 212 to allow the fluid coupling 210 to slip. For example, the clutch control circuitry 514 can cause the pressurized fluid system 242 to disengage/open the lock-out clutch 212 to facilitate slip between the output shaft 214 and the drive shaft 216.

At block 704, the slip condition circuitry 420 determines a desired slip for the fluid coupling 210 to obtain a desired energy loss associated with the slip condition request. For example, the slip determination circuitry 532 can determine the desired slip based on the information from the sensors 260 and/or the MCU 262. In some examples, the slip determination circuitry 532 determines the desired slip via a loss-to-slip lookup table in the database 518.

At block 706, the slip condition circuitry 420 determines a motor speed needed for the desired slip based on a vehicle command speed (e.g., a speed associated with a user input and/or a requested speed from an at least partially autonomous driving system). For example, the motor speed determination circuitry 516 can determine the motor speed based on the desired slip and the vehicle command speed. In some examples, the motor speed determination circuitry 516 determines the motor speed based on (i) a speed of the drive shaft 216 associated with the vehicle command speed and (ii) a difference between a speed of the output shaft 214 and the speed of the drive shaft 216 that provides the desired slip.

At block 708, the slip condition circuitry 420 determines a torque multiplication of the fluid coupling 210 based on the motor speed and the slip. For example, the torque multiplication circuitry 534 can determine torque multiplication based on the determined motor speed and the slip between the output shaft 214 and the drive shaft 216.

At block 710, the slip condition circuitry 420 determines a desired motor torque output based on the determined torque multiplication to achieve the vehicle command speed. For example, the motor torque determination circuitry 520 can determine the torque output for the electric motor 202 based on the torque multiplication and the vehicle command speed.

At block 712, the slip condition circuitry 420 operates the electric motor 202 in a speed control mode to achieve the desired motor torque output associated with the vehicle command speed. For example, to operate the motor at the desired motor torque, the motor torque determination circuitry 520 can cause the MCU 262 to adjust a voltage or a frequency of an electronic signal supplied to the electric motor 202. Further, the motor speed determination circuitry 516 can maintain the electric motor 202 at the motor speed needed for the desired slip by causing the MCU 262 to supply a current to the electric motor 202 that corresponds with the determined motor speed. When the operations 700 of FIG. 7 are complete, control returns to the operations 600 of FIG. 6 at block 624.

FIG. 8 is a flowchart representative of example machine readable instructions and/or example operations 800 that may be executed, instantiated, and/or performed by example programmable circuitry to facilitate vehicle operations that perform a slip condition request when the loss mode request is not for heat (e.g., a slip condition request during a regenerative braking event). The example machine-readable instructions and/or the example operations 800 of FIG. 8 begin at block 802, at which the slip condition circuitry 420 detects a regeneration energy loss request. In some examples, the MCU 262 determines that the EV 100 is to enter a regeneration mode based on a grade (e.g., a slope or angle) of the EV 100 from input received by an accelerometer.

At block 804, the slip condition circuitry 420 determines whether a charge capacity of the battery of the EV 100 exceeds a charge threshold. For example, the state of charge determination circuitry 536 can determine whether a charge capacity of the battery of the EV 100 is greater than the charge threshold (e.g., 98% of a total capacity, 95% of a total capacity, 90% of a total capacity, etc.). If the state of charge determination circuitry 536 determines that a charge capacity of the battery exceeds the charge threshold, the operations 800 move to block 820. Otherwise, if the state of charge determination circuitry 536 determines that a charge capacity of the battery does not exceed the threshold, the operations 800 proceed to block 806. For instance, energy generated by a regenerative braking event is to be dissipated by the fluid coupling when the battery is at a charge capacity for which the battery cannot accept any additional energy.

At block 806, the slip condition circuitry 420 disengages/opens the lock-out clutch 212 to allow the fluid coupling 210 to slip. Accordingly, at block 806, the slip condition circuitry 420 initiates a non-charging mode during a regenerative braking event. For example, the clutch control circuitry 514 can cause the pressurized fluid system 242 to disengage/open the lock-out clutch 212 to facilitate slip between the output shaft 214 and the drive shaft 216.

At block 808, the slip condition circuitry 420 determines a speed of the electric motor 202. For example, the motor speed determination circuitry 516 can determine a speed at which the electric motor 202 is to operate based on information from the sensors 260 and/or the MCU 262.

At block 810, the slip condition circuitry 420 determines an output speed of the EV 100 (e.g., a speed of the drive shaft 216). For example, the slip condition circuitry 420 can determine the speed of the EV 100 based on information from the sensors 260 and/or the MCU 262.

At block 812, the slip condition circuitry 420 determines a desired slip needed to achieve an energy loss or dissipation associated with the slip condition request. For example, the slip determination circuitry 532 can determine the desired slip to obtain a desired energy loss (e.g., a desired mechanical energy loss) associated with the slip condition via a loss-to-slip lookup table stored in the database 518.

At block 814, the slip condition circuitry 420 operates the electric motor 202 in a speed control mode to maintain the desired slip in the fluid coupling 210. For example, the motor speed determination circuitry 516 determines the motor speed based on the desired slip and the vehicle command speed requested by the user and/or an autonomous driving system. In some examples, the motor speed determination circuitry 516 determines the motor speed based on (i) a speed of the drive shaft 216 associated with the vehicle command speed and (ii) a difference between a speed of the output shaft 214 and the speed of the drive shaft 216 that provides the desired slip.

At block 816, the slip condition circuitry 420 determines a torque multiplication of the fluid coupling 210 based on the motor speed and the slip. For example, the torque multiplication circuitry 534 can determine torque multiplication based on the determined motor speed and the slip between the output shaft 214 and the drive shaft 216.

At block 818, the slip condition circuitry 420 determines a negative motor torque command based on the torque multiplication for a desired braking command. For example, the motor torque determination circuitry 520 can determine the negative torque command for the electric motor 202 based on the torque multiplication and the vehicle command speed.

At block 820, the slip condition circuitry 420 adjusts a torque output by the electric motor 202 based on the determined negative torque command to achieve a desired braking operation and energy dissipation in parallel. For example, to operate the motor at the desired motor torque, the motor torque determination circuitry 520 can cause the MCU 262 to adjust a voltage or a frequency of an electronic signal supplied to the electric motor 202. Further, the motor speed determination circuitry 516 can maintain the electric motor 202 at the motor speed needed for the desired slip by causing the MCU 262 to supply a current to the electric motor 202 that corresponds with the determined motor speed. After block 820, the operations 800 return to the operations 600 of FIG. 6 at block 632.

At block 822, the slip condition circuitry 420 determines whether a temperature of the battery of the EV 100 exceeds a temperature threshold (e.g., a low temperature threshold, a temperature of approximately 0 degrees Celsius (°°C.), 32 degrees Fahrenheit (° F.)). For example, the temperature threshold can be a temperature threshold (e.g., a minimum temperature) associated with enhanced performance and/or lifespan expansion of the battery. If the battery temperature determination circuitry 506 determines that a temperature of the battery exceeds the temperature threshold at block 822, the operations 800 proceed to block 824. Otherwise, if the battery temperature determination circuitry 506 determines that the temperature of the battery does not exceed the temperature threshold, the operations 800 proceed to block 806.

At block 824, the slip condition circuitry 420 engages/closes the lock-out clutch 212 to prevent slip. For example, the clutch control circuitry 514 can cause the pressurized fluid system 242 to engage/close the lock-out clutch 212 to prevent slip between the output shaft 214 and the drive shaft 216.

At block 826, the slip condition circuitry 420 operates in a regenerative braking energy capture mode (e.g., a regeneration condition). After block 826, the operations 800 return to the operations 600 of FIG. 6 at block 632.

The foregoing examples of the machine readable instructions and/or example operations 600-800 can be employed by the slip condition circuitry 420 to control slip condition operations in a vehicle. Although each example machine readable instructions and/or example operations 600-800 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

FIG. 9 is a block diagram of an example programmable circuitry platform 900 structured to execute and/or instantiate the example machine-readable instructions and/or the example operations of FIGS. 6-8 to implement the example slip condition circuitry 420 of FIGS. 3-5. The programmable circuitry platform 900 can be, for example, a server, a personal computer, a workstation, a self-learning machine (e.g., a neural network), a mobile device (e.g., a cell phone, a smart phone, a tablet), or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example slip condition circuitry 420, the example slip condition identification circuitry 502, the example cabin temperature determination circuitry 504, the example battery temperature determination circuitry 506, the example component temperature monitor circuitry 508, the example vehicle speed detection circuitry 510, the example brake circuitry 512, the example clutch control circuitry 514, the example motor speed determination circuitry 516, the example motor torque determination circuitry 520, the example mechanical power determination circuitry 522, the example energy loss detection circuitry 524, the example valve operator circuitry 528, the example slip determination circuitry 532, the example torque multiplication circuitry 534, and the example regeneration braking circuitry 536.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 920 of the illustrated example, thus, includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 5-8, may be stored in the mass storage device 928, in the volatile memory 914, in the non-volatile memory 916, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that utilize a fluid coupling for heating and/or energy dissipation in electric vehicles. Further examples and combinations thereof include the following:
Example 1 includes an apparatus comprising a torque converter to operatively couple an output shaft of an electric motor and a drive shaft of a vehicle, a clutch movable between an engaged position and a disengaged position, the clutch to fluidly couple the output shaft and the drive shaft via a first fluid of the torque converter when the clutch is in the disengaged position, the clutch to mechanically couple the output shaft and the drive shaft when the clutch is in the engaged position, and a heating system to extract heat from the first fluid of the torque converter to increase a temperature of a second fluid, the second fluid to provide heat to at least one of a cabin of the vehicle or a battery of the vehicle.
Example 2 includes the apparatus of example 1, wherein the heating system includes a heat exchanger, the heat exchanger having a first inlet to receive the first fluid and a first outlet to return the first fluid to the torque converter, the heat exchanger having a second inlet to receive the second fluid and a second outlet to discharge the second fluid, wherein the second fluid extracts heat from the first fluid when the first fluid and the second fluid pass through the heat exchanger.
Example 3 includes the apparatus of example 1, wherein the heat exchanger is a fluid-to-fluid heat exchanger, a shell and tube heat exchanger, a plate heat exchanger, a brazed plate heat exchanger, a round-tube-fin (RTPF) heat exchanger, or a microchannel heat exchanger.
Example 4 includes the apparatus of example 1, wherein the clutch is to enable slip between the output shaft and the drive shaft when the clutch is in the disengaged position, the clutch to prevent slip between the output shaft and the drive shaft when the clutch is in the engaged position.
Example 5 includes the apparatus of example 1, wherein the torque converter is a hydraulic torque converter.
Example 6 includes the apparatus of example 1, wherein the torque converter includes a turbine and an impeller, wherein the impeller is coupled to the output shaft and the turbine is coupled to the drive shaft.
Example 7 includes the apparatus of example 6, wherein the clutch is slidably coupled to the turbine.
Example 8 includes the apparatus of example 7, wherein the first fluid of the torque converter generates heat when the clutch is disengaged and the impeller rotates at a first speed different than a second speed of the turbine.
Example 9 includes the apparatus of example 1, wherein the heating system includes a first valve operatively coupled to the torque converter, the first valve movable between a first open position and a first closed position, the first valve in the first open position to allow the first fluid from the torque converter to flow through the heating system, the first valve in the closed position to prevent the first fluid of the torque converter from flowing to the heating system.
Example 10 includes the apparatus of example 9, further including a controller to cause the first valve to move to the first open position in response to detecting a torque converter slip condition of the vehicle.
Example 11 includes the apparatus of example 10, further including a second valve fluidly coupled to the clutch, the second valve movable between a second open position and a second closed position, in the second open position, the second valve causes the clutch to move to the engaged position to mechanically couple the output shaft and the drive shaft, and in the second closed position, the second valve causes the clutch to move to the disengaged position to fluidly couple the output shaft and the drive shaft.
Example 12 includes the apparatus of example 1, further including control circuitry, the control circuitry to cause the clutch to move to the disengaged position in response to detecting at least one of (1) a cabin temperature of the vehicle less than a cabin command temperature or (2) a battery system temperature less than a battery temperature threshold.
Example 13 includes the apparatus of example 12, further including control circuitry, the control circuitry to cause the clutch of the torque converter to move to the disengaged position in response to detecting (1) a charge status of the battery system of the vehicle that is greater than a charge threshold, and (2) the vehicle operating in a regeneration condition.
Example 14 includes the apparatus of example 1, wherein the first fluid is oil and the second fluid is coolant.
Example 15 includes an apparatus comprising an electric motor having an output shaft, a drive shaft to drive one or more wheels of a vehicle, a fluid torque converter to operatively couple the output shaft of the electric motor and the drive shaft, a clutch movable between an engaged position and a disengaged position, the clutch to fluidly couple the output shaft of the electric motor and the drive shaft when the clutch is in the disengaged position, the clutch to enable the electric motor to bypass the fluid torque converter to mechanically couple the output shaft of the electric motor and the drive shaft when the clutch is in the engaged position, interface circuitry, machine readable instructions, and programmable circuitry to at least one of instantiate or execute the machine readable instructions to detect a torque converter slip condition request, and move the clutch to the disengaged position in response to at least one of determining a cabin temperature that is less than a cabin temperature threshold, determining a battery temperature that is less than a battery temperature threshold, or determining a regeneration mode and at least one of determining a state of charge of the battery exceeding a charge capacity threshold or the battery temperature less than the battery temperature threshold.
Example 16 includes the apparatus of example 15, wherein the programmable circuitry is to cause a fluid valve to move to an open position to allow fluid from the torque converter to flow to a heat exchanger in response to detecting the torque converter slip condition and the clutch in the disengaged position.
Example 17 includes the apparatus of example 15, wherein the determining of the regeneration mode includes receiving a request from a motor control unit.
Example 18 includes At least one non-transitory machine-readable medium comprising machine-readable instructions to cause at least one processor circuit to detect a torque converter slip condition request, detect a cabin temperature, detect a battery temperature of a battery, determine a state of charge capacity of the battery, detect a non-regeneration mode or a regeneration mode, and in response to detecting the non-regeneration mode, cause a clutch of a torque converter to move to a disengaged position in response to at least one of determining the cabin temperature is less than a cabin temperature threshold, or determining a battery temperature is less than a battery temperature threshold, or in response to detecting the regeneration mode, cause the clutch of the torque converter to move to the disengaged position in response to at least one of the state of charge of the battery exceeding a charge capacity threshold or the battery temperature not exceeding the battery temperature threshold.
Example 19 includes the at least one non-transitory machine-readable medium of example 18, wherein the machine-readable instructions are to cause a fluid valve to move to an open position to allow fluid from the torque converter to flow to a heat exchanger in response to detecting the torque converter slip condition and the clutch in the disengaged position.
Example 20 includes the at least one non-transitory machine-readable medium of example 18, wherein the machine-readable instructions are to receive a torque converter slip condition from a motor control unit to detect the torque converter slip condition request.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a torque converter to operatively couple an output shaft of an electric motor and a drive shaft of a vehicle;
a clutch movable between an engaged position and a disengaged position, the clutch to fluidly couple the output shaft and the drive shaft via a first fluid of the torque converter when the clutch is in the disengaged position, the clutch to mechanically couple the output shaft and the drive shaft when the clutch is in the engaged position; and
a heating system to extract heat from the first fluid of the torque converter to increase a temperature of a second fluid, the second fluid to provide heat to at least one of a cabin of the vehicle or a battery of the vehicle.

2. The apparatus of claim 1, wherein the heating system includes a heat exchanger, the heat exchanger having a first inlet to receive the first fluid and a first outlet to return the first fluid to the torque converter, the heat exchanger having a second inlet to receive the second fluid and a second outlet to discharge the second fluid, wherein the second fluid extracts heat from the first fluid when the first fluid and the second fluid pass through the heat exchanger.

3. The apparatus of claim 1, wherein the heat exchanger is a fluid-to-fluid heat exchanger, a shell and tube heat exchanger, a plate heat exchanger, a brazed plate heat exchanger, a round-tube-fin (RTPF) heat exchanger, or a microchannel heat exchanger.

4. The apparatus of claim 1, wherein the clutch is to enable slip between the output shaft and the drive shaft when the clutch is in the disengaged position, the clutch to prevent slip between the output shaft and the drive shaft when the clutch is in the engaged position.

5. The apparatus of claim 1, wherein the torque converter is a hydraulic torque converter.

6. The apparatus of claim 1, wherein the torque converter includes a turbine and an impeller, wherein the impeller is coupled to the output shaft and the turbine is coupled to the drive shaft.

7. The apparatus of claim 6, wherein the clutch is slidably coupled to the turbine.

8. The apparatus of claim 7, wherein the first fluid of the torque converter is to generate heat when the clutch is disengaged and the impeller rotates at a first speed different than a second speed of the turbine.

9. The apparatus of claim 1, wherein the heating system includes a first valve operatively coupled to the torque converter, the first valve movable between a first open position and a first closed position, the first valve in the first open position to allow the first fluid from the torque converter to flow through the heating system, the first valve in the closed position to prevent the first fluid of the torque converter from flowing to the heating system.

10. The apparatus of claim 9, further including a controller to cause the first valve to move to the first open position in response to detecting a torque converter slip condition of the vehicle.

11. The apparatus of claim 10, further including a second valve fluidly coupled to the clutch, the second valve movable between a second open position and a second closed position;
in the second open position, the second valve causes the clutch to move to the engaged position to mechanically couple the output shaft and the drive shaft; and
in the second closed position, the second valve causes the clutch to move to the disengaged position to fluidly couple the output shaft and the drive shaft.

12. The apparatus of claim 1, further including control circuitry, the control circuitry to cause the clutch to move to the disengaged position in response to detecting at least one of: (1) a cabin temperature of the vehicle less than a cabin command temperature or (2) a battery system temperature less than a battery temperature threshold.

13. The apparatus of claim 12, further including control circuitry, the control circuitry to cause the clutch of the torque converter to move to the disengaged position in response to detecting: (1) a charge status of the battery system of the vehicle that is greater than a charge threshold; and (2) the vehicle operating in a regeneration condition.

14. The apparatus of claim 1, wherein the first fluid is oil and the second fluid is coolant.

15. An apparatus comprising:
an electric motor having an output shaft;
a drive shaft to drive one or more wheels of a vehicle;
a fluid torque converter to operatively couple the output shaft of the electric motor and the drive shaft;
a clutch movable between an engaged position and a disengaged position, the clutch to fluidly couple the output shaft of the electric motor and the drive shaft when the clutch is in the disengaged position, the clutch to enable the electric motor to bypass the fluid torque converter to mechanically couple the output shaft of the electric motor and the drive shaft when the clutch is in the engaged position;
interface circuitry;
machine readable instructions; and
programmable circuitry to at least one of instantiate or execute the machine readable instructions to:
detect a torque converter slip condition request; and
move the clutch to the disengaged position in response to at least one of:
determining a cabin temperature that is less than a cabin temperature threshold;
determining a battery temperature that is less than a battery temperature threshold; or
determining a regeneration mode and at least one of determining a state of charge of the battery exceeding a charge capacity threshold or the battery temperature less than the battery temperature threshold.

16. The apparatus of claim 15, wherein the programmable circuitry is to cause a fluid valve to move to an open position to allow fluid from the torque converter to flow to a heat exchanger in response to detecting the torque converter slip condition and the clutch in the disengaged position.

17. The apparatus of claim 15, wherein the determining of the regeneration mode includes receiving a request from a motor control unit.

18. At least one non-transitory machine-readable medium comprising machine-readable instructions to cause at least one processor circuit to at least:
detect a torque converter slip condition request;
detect a cabin temperature;
detect a battery temperature of a battery;
determine a state of charge capacity of the battery;
detect a non-regeneration mode or a regeneration mode; and
in response to detecting the non-regeneration mode, cause a clutch of a torque converter to move to a disengaged position in response to at least one of: determining the cabin temperature is less than a cabin temperature threshold, or determining a battery temperature is less than a battery temperature threshold; or
in response to detecting the regeneration mode, cause the clutch of the torque converter to move to the disengaged position in response to at least one of: the state of charge of the battery exceeding a charge capacity threshold or the battery temperature not exceeding the battery temperature threshold.

19. The at least one non-transitory machine-readable medium of claim 18, wherein the machine-readable instructions are to cause a fluid valve to move to an open position to allow fluid from the torque converter to flow to a heat exchanger in response to detecting the torque converter slip condition and the clutch in the disengaged position.

20. The at least one non-transitory machine-readable medium of claim 18, wherein the machine-readable instructions are to receive a torque converter slip condition from a motor control unit to detect the torque converter slip condition request.
